(19) United States
(12) Patent Application Publication
(10) Pub. No.: US 2020/0037052 A1
(43) Pub. Date: Jan. 30, 2020

(54) APPARATUS, CONTROL SYSTEM, APPARATUS CONTROL METHOD, AND PROGRAM

(71) Applicant: NEC CORPORATION, Tokyo (JP)

(72) Inventor: Norio UCHIDA, Tokyo (JP)

(73) Assignee: NEC CORPORATION, Tokyo (JP)

(21) Appl. No.: 16/498,252

(22) PCT Filed: Mar. 27, 2018
(86) PCT No.: PCT/JP2018/012523

§ 371 Date: Sep. 26, 2019

(30) Foreign Application Priority Data
Mar. 29, 2017 (JP) 2017-066160

(51) Int. Cl. H04Q 9/00

(52) U.S. Cl. CPC H04Q 9/00; H04Q 2213/13242

(57) ABSTRACT

An apparatus is provided with: a storage part that stores a value corresponding to at least one type; a receiving part that receives a broadcast message which includes a condition representing the value corresponding to the type from a control apparatus via a network; a condition determination part that determines whether or not the value stored in the storage part satisfies the condition included in the broadcast message; a process execution part that executes a predetermined processing in a case where the value stored in the storage part satisfies the condition.

### REFERENCE TO RELATED APPLICATION

This application is a National Stage of International Application No. PCT/JP2018/012523 filed Mar. 27, 2018 claiming priority based of Japanese patent application No. 2017-066160, filed on Mar. 29, 2017, the disclosure of which is incorporated herein in its entirety by reference thereto.

### FIELD

The present invention relates to an apparatus, a control system, an apparatus control method, and a program.

### BACKGROUND

In recent years, IoT (Internet of Things) has diversified the use of each apparatus, which caused increase in the case of using various apparatus via a network. Furthermore, with the increase in utilization of various apparatus via the network, there is an increasing need to control a plurality of apparatus via the network.

Patent Literature 1 discloses a technique for controlling a plurality of apparatus via a network by sending control instruction execution policy describing a condition for executing control instruction and contents of the control instruction to be executed, via a network.

Patent Literature 2 discloses a technique in which an apparatus that receives a packet and stores a condition for determining whether to discard the received packet. Then, in the technology described in Patent Literature 2, each apparatus can execute processing on an appropriate packet by discarding an inappropriate received packet based on the condition stored in advance.

PTL1: JP-Tokuhyo (Publication of Japanese Translation of PCT International Application) No.2012-502578A

PTL2: Japanese Patent Kokai Publication No. JP2010-178275A

### SUMMARY

The disclosure of the above prior art Literatures is incorporated herein by reference. The following analysis has been made from the point of view of the present invention.

In a case where a control apparatus controls a plurality of apparatus via a network, when the control apparatus individually sends a control instruction to each apparatus, the more frequently the control instruction is sent, the more traffic amount flows through the network. Similarly, when a control apparatus sends a control instruction to each apparatus individually, the traffic amount through the network increases as the number of target apparatus increases.

On the other hand, when a control apparatus sends a control instruction to a broadcast address, it is possible to suppress increase in the traffic amount flowing through the network. However, in this case, the control apparatus cannot cause each apparatus to execute a different control instruction.

In the technology disclosed in Patent Literature 1, in order to cause each apparatus to execute a different control instruction, it is necessary to send, to each apparatus, a control instruction execution policy that describes different condition(s) and processing to be executed. Therefore, in the technique disclosed in Patent Literature 1, as the number of target apparatus increases, there is a possibility that traffic amount flowing via the network might increase. Further, in the technology disclosed in Patent Literature 1, when control instruction execution policy is sent to the broadcast address, a different processing cannot be performed on each apparatus.

In the technique disclosed in Patent Literature 2, an apparatus that receives a packet determines whether or not to discard the received packet according to a condition stored in advance. Therefore, in the technology disclosed in Patent Literature 2, it is necessary to set a different condition in each apparatus in order to cause each apparatus that receives a packet to execute a different processing. Therefore, in the technique disclosed in Patent Literature 2, when simultaneously changing a processing executed by a plurality of apparatus, it is necessary to send a message specifying different condition to each of the plurality of apparatus. Therefore, in the technique disclosed in Patent Literature 2, there is a possibility that traffic amount flowing via the network may increase when the processing executed by the plurality of apparatus is simultaneously changed.

Therefore, it is an object of the present invention to provide an apparatus, a control system, an apparatus control method, and a program that contribute to realizing the control of each apparatus efficiently and easily.

According to a first aspect, there is provided an apparatus. The apparatus comprises a storage part that stores a value corresponding to at least one type. Furthermore, the apparatus comprises a receiving part that receives a broadcast message which includes a condition representing the value corresponding to the type, from a control apparatus via a network. The apparatus further comprises a condition determination part that determines whether or not the value stored in the storage part satisfies the condition included in the broadcast message. The apparatus further comprises a process execution part that executes a predetermined processing in a case where the value stored in the storage part satisfies the condition.

According to a second aspect, there is provided a control system. The control system comprises a control apparatus that sends a broadcast message which includes a condition corresponding to at least one type. The control system further comprises one or more apparatus that connects to the control apparatus via a network. The apparatus connected to the control apparatus further comprises,

a storage part that stores a value corresponding to at least one type,

a receiving part that receives the broadcast message which includes a condition representing the value corresponding to the type, from the control apparatus via the network,

a condition determination part that determines whether or not the value stored in the storage part satisfies the condition included in the broadcast message,

a process execution part that executes a predetermined processing in a case where the value stored in the storage part satisfies the condition.

According to a third aspect, there is provided an apparatus control method. The apparatus control method, wherein an apparatus has a storage part that stores a value corresponding to at least one type, comprises receiving a broadcast message via a network which include a condition representing the value corresponding to the type. The apparatus control method further comprises determining whether or not the value satisfies the condition included in the broadcast message. The control method further comprises executing a predetermined processing in a case where the value satisfies the condition. Note that the method is directed to work with a specific machine, that is, apparatus that connects to the control apparatus via a network.

According to a fourth aspect, there is provided a program. The program is a program that causes a computer that controls an apparatus having a storage part which stores a value corresponding to at least one type. The program causes the computer to execute a process of receiving a broadcast message which includes a condition representing the value corresponding to the type. Also, the program causes the computer to execute a process of determining whether or not the value satisfies the condition included in the broadcast message. Also, the program causes the computer to execute a process of executing a predetermined processing in a case where the value satisfies the condition. The program can be recorded on a computer readable storage medium. The storage medium can be non-transient one such as semiconductor memory, hard disk, a magnetic recording medium, optical recording medium, and so on. The invention can also be realized as a computer program product.

According to each aspect, an apparatus, a control system, an apparatus control method, and a program that contribute to realizing the control of each apparatus efficiently and easily, are provided.

### BRIEF DESCRIPTION OF THE DRAWINGS

FIG. 1 illustrates an outline explanation of a first example embodiment.

FIG. 2 illustrates a block diagram to show an example of a whole configuration of a control system of a second example embodiment.

FIG. 3 illustrates an example of a configuration of a broadcast message 200.

FIG. 4 illustrates a block diagram to show an example of an internal configuration of an apparatus 101 concerning the first example embodiment.

FIG. 5 illustrates a flowchart to show an example of operation of the apparatus 101 concerning the first example embodiment.

FIG. 6 illustrates an example of a configuration of a broadcast message 210.

FIG. 7 illustrates a block diagram to show an example of an internal configuration of an apparatus 500 concerning the second example embodiment.

FIG. 8 illustrates a flowchart to show an example of internal configuration of apparatus 500 concerning a second example embodiment.

### MODES

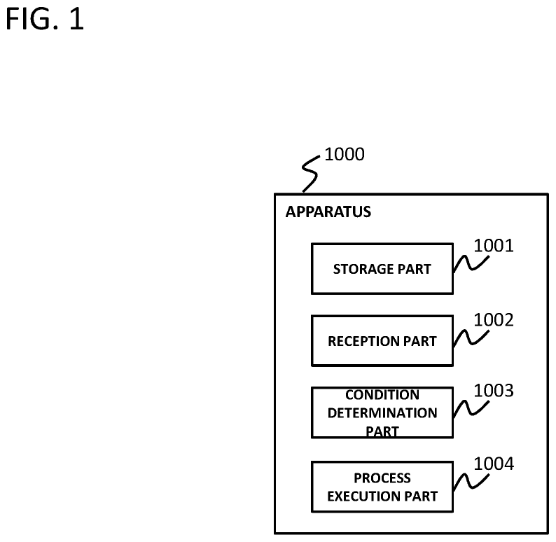

First, an outline of a first example embodiment will be described with reference to FIG. 1. The reference symbols of the drawings appended to this summary are added for the sake of convenience to each element as an example for aiding understanding, and the description of the summary is not intended to be limitative any way. Also, connection line(s) between blocks in each block diagram includes both bidirectional and unidirectional directions. The unidirectional arrows schematically indicate the flow of main signals (data), and do not exclude bidirectionality.

As mentioned before, an apparatus that contributes to efficiently and easily achieving individual apparatus control is desired.

Thus, as an example, an apparatus 1000 shown in FIG. 1 is provided. The apparatus 1000 includes a storage part 1001, a reception part 1002, a condition determination part 1003, and a process execution part 1004. The apparatus 1000 connects to a control apparatus via a network.

The storage part 1001 stores a value corresponding to at least one type.

The receiving part 1002 receives a broadcast message which includes a condition corresponding to at least one type from the control apparatus via the network. Here, the condition included in the broadcast message is related to condition regarding the type of a value which is stored in the storage part 1001.

The condition determination part 1003 determines whether the value stored in the storage part 1001 satisfies the condition included in the received broadcast message.

When the value stored in the storage part 1001 satisfies the condition included in the broadcast message, the process execution part 1004 executes a predetermined processing.

For example, it is assumed that a plurality of (two or more) apparatus 1000 receive the broadcast message sent from the control apparatus. In this case, each apparatus 1000 determines whether the value stored in the apparatus 1000 satisfies the condition included in the broadcast message. Then, each apparatus 1000 executes the processing in a case where the value stored in the apparatus 1000 satisfies the condition.

Thus, even if the plurality of apparatus 1000 receive the same condition, each apparatus 1000 determines whether the control instruction to be executed according to the value stored in the apparatus 1000. Therefore, the control apparatus need not to be set different conditions for each apparatus 1000 in order to cause each apparatus 1000 to perform different processing. Therefore, the apparatus 1000 contributes to the efficient and easy implementation of individual apparatus control.

### First Example Embodiment

A first example embodiment will be described in more detail using the drawings.

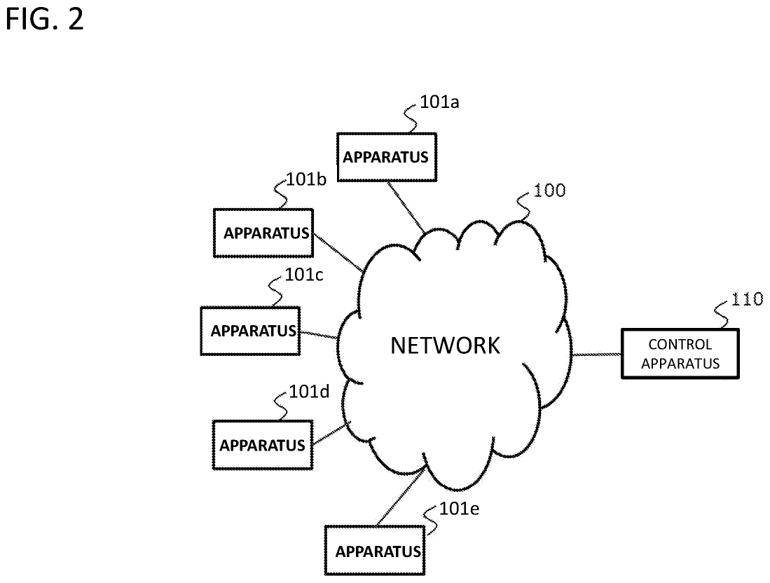

FIG. 2 illustrates a block diagram to show an example of the overall configuration of a control system according to the present example embodiment. The control system according to the present example embodiment is configured to include one or more apparatus (101a to 101e) and a control apparatus 110. The apparatus (101a to 101e) communicate with the control apparatus 110 via a network 100. In the following description, the apparatus (101a to 101e) will be referred to as “apparatus 101” unless it is necessary to distinguish them. Moreover, although FIG. 2 shows five apparatus 101, this does not mean to limit the apparatus to five. The control system according to the present example embodiment may be configured to include one to four, or six or more apparatus 101.

The apparatus 101 is a terminal apparatus, for example, a terminal apparatus including a computer, and is typically configured to include CPU (Central Processing Unit), memory, communication unit, and so on. Furthermore, the apparatus 101 may be, for example, a temperature sensor, a humidity sensor, a lighting apparatus, an air conditioning apparatus, an office automation (OA) apparatus, a factory automation (FA) apparatus, a distribution board, a mobile terminal, a large machine (for example, a vehicle).

The network 100 is a communication network that connects one or more apparatus 101 to the control apparatus 110. For example, the network 100 may be a mobile communication network, a Transmission Control Protocol/Internet Protocol (TCP/IP) network, or Ethernet (registered trademark). Alternatively, the network 100 may be a wireless LAN (Local Area Network) compliant with IEEE 802.11, Zigbee (registered trademark), or Bluetooth (registered trademark).

Further, it is assumed that the network 100 can execute broadcast messaging. Here, broadcast messaging means broadcasting a predetermined message and/or packet to the entire network 100 and/or two or more nodes belonging to a predetermined network segment. For example, suppose that packets are broadcasted simultaneously in an IPv4 (Internet Protocol version 4) network. In this case, a node that belongs to the same network segment as a node sending the packet determines that the destination of the packet is for the node concerned, and the node receives the packet. In the following description, message broadcasted simultaneously in the network 100 is called broadcast message.

The control apparatus 110 is configured to include an apparatus (computer) that controls the apparatus 101, and typically includes a central processing unit (CPU), memory, communication unit, and so on. The control apparatus 110 sends the broadcast message to the apparatus 101. The control apparatus 110 sends a control instruction to the apparatus 101 via the network 100. The control apparatus 110 may be a server apparatus, a desktop computer, a mobile terminal, a home gateway, a broadband router, or a M2M (Machine to Machine) service platform.

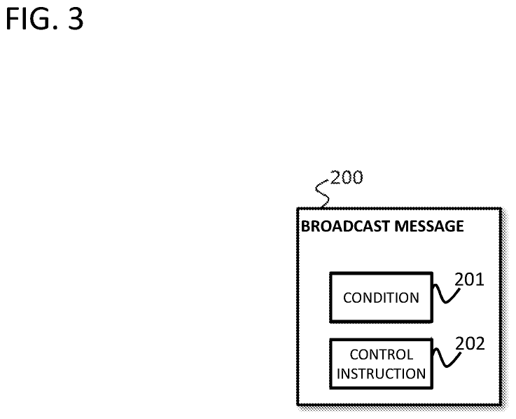

FIG. 3 illustrates a diagram to show an example of a configuration of the broadcast message 200. The broadcast message 200 is configured to include a condition 201 and a control instruction 202.

The condition 201 is related to a value stored in the apparatus 101 (hereinafter, referred to as a value X). For example, the condition 201 may be a condition such as “the value X is smaller than 3 (X<3)”, “the value X is equal to 5 (X=5)”, and so on. Alternatively, for example, when the value X stored in the apparatus 101 represents a time (point of time), the condition 201 may be a condition such as “a difference between a time represented by the value X and a current time is 3 hours or more”. Alternatively, the condition 201 may be a condition such as “lower three digits of the value X are equal to 393”.

Furthermore, when the apparatus 101 stores a plurality of (two or more) values, the condition 201 may be a condition regarding a plurality of values. For example, assume that the apparatus 101 stores the value X and a value Y. In this case, the condition 201 may be a condition such as “the value X is smaller than 3” AND “the value Y is equal to 5”. Further, for example, it is assumed that the apparatus 101 stores the value X, a value x, the value Y, a value y. In this case, the condition 201 may be a condition such as “(value X−value x)\hat{ }2+(value Y−value y)\hat{ }2<25”.

The control instruction 202 indicates the content of the processing that the apparatus 101 executes.

For example, the control instruction 202 may indicate processing such as power on/off of the apparatus 101. Alternatively, the control instruction 202 may indicate a processing of transmitting a signal from the apparatus 101 to a specific address. Alternatively, the control instruction 202 may indicate a processing of updating an internal setting of the apparatus 101.

Alternatively, for example, assume that the apparatus 101 is a lighting apparatus. In this case, the control instruction 202 may include on/off instruction of the apparatus, also may include processing such as up/down (increase/decrease) of illumination.

Alternatively, for example, the apparatus 101 is assumed to be a heating and cooling apparatus. In this case, the control instruction 202 may include processing of temperature setting, in addition to an on/off command of the apparatus.

Alternatively, the control instruction 202 may be an arithmetic processing (for example, addition, subtraction, multiplication, division) on the value used by the condition 201 (i.e. the value stored in the apparatus 101).

Alternatively, for example, it is assumed that the apparatus 101 stores the value used in the past together with a timestamp at that time. In this case, the control instruction 202 may indicate processing of applying a value at a predetermined time in the past (for example, January 23, 11: 0: 00) as a current value.

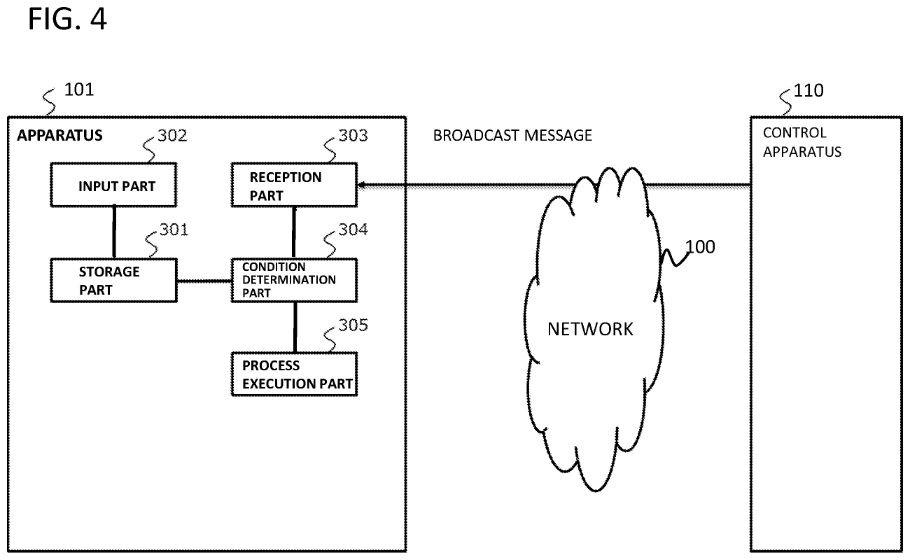

FIG. 4 illustrates a block diagram to show an example of an internal configuration of the apparatus 101. The apparatus 101 is configured to include a storage part 301, an input part 302, a reception part 303, a condition determination part 304, and a process execution part 305.

The storage part 301 stores an arbitrary value. For example, the storage part 301 may be realized using read only memory (ROM), random access memory (RAM), hard disk drive (HDD), solid state drive (SDD), magnetic tape, and so on.

The storage part 301 stores a value corresponding to at least one type. In particular, the storage part 301 stores at least one selected from the group consisting of a fixed value and a variable value corresponding to at least one type. Alternatively, the storage part 301 may store one or more values corresponding to one type.

Specifically, the apparatus 101 determines a value based on at least one selected from the group consisting of a setting information, an attribute, a state of the apparatus 101, and stores the determined value in the storage part 301.

For example, the storage part 301 may hold a network address, information for specifying the apparatus 101 (apparatus ID (Identifier)), information for specifying a manufacturer, manufacturing date, manufacturing number, operation start date, and so on. Also, for example, the storage part 301 holds information specifying the installation location of the apparatus 101, information specifying the administrator, information specifying the affiliation of the administrator of the apparatus 101, the telephone number of the administrator of the apparatus 101, and so on.

Alternatively, for example, the storage part 301 may hold information indicating the power supply state of the apparatus 101, information identifying the operating state, information identifying the failure of the apparatus 101, strength of the received signal, internal temperature, signal reception history (such as datetime of the signal reception), and so on.

The apparatus 101 may be configured to include a sensor(s) (not shown) that detects the state of the apparatus 101 itself or the state of a predetermined object. In this case, the storage part 301 may hold (store) value(s) measured by the sensor(s). For example, the storage part 301 may hold measured values of the sensor(s), such as temperature, humidity, illuminance, speed, acceleration, weight, length, distance, area, volume, concentration, density, viscosity, particle size, electric field strength, magnetic field strength, electric current, voltage, and so on.

The input part 302 receives an input of information. Then, the input part 302 transmits the acquired information to the storage part 301. Details do not matter, as long as the input part 302 can receive the information. For example, the input part 302 may be realized using keyboard, dial, push button, touch panel, jumper switch, IC (Integrated Circuit) card reader, bar code reader, two-dimensional code reader, camera, microphone, and so on.

The receiving part 303 receives the broadcast message 200 sent simultaneously to the network 100. For example, the receiving part 303 may be realized using wired or wireless receiver, network interface card (NIC).

Specifically, the receiving part 303 receives the broadcast message 200 including the condition 201 from the control apparatus 110 via the network. Here, it is assumed that the condition 201 corresponds to the type of the value stored (held) in the storage part 301.

The condition determination part 304 determines whether the value held (stored) in the storage part 301 satisfies the condition 201 included in the received broadcast message 200. For example, the condition determination part 304 may be realized using logic circuit. Alternatively, for example, the condition determination part 304 may be realized using a software program and an execution environment (such as memory, arithmetic unit, storage apparatus) of the software program.

The process execution part 305 executes the contents of the control command 202 included in the received broadcast message 200. Specifically, in a case where the condition determination part 304 determines that the value held by the storage part 301 satisfies the condition 201 included in the received broadcast message 200, the process execution part 305 execute the content of the control instruction 202 included in the broadcast message 200.

The process execution part 305 may execute a predetermined processing in a case where the condition determination part 304 determines that the value held by the storage part 301 satisfies the condition 201 included in the received broadcast message 200.

For example, the process execution part 305 may be realized using logic circuit. Alternatively, for example, the process execution part 305 may be realized using a software program and an execution environment (such as memory, arithmetic unit, storage apparatus) of the software program.

Also, in a case where the process execution part 305 executes the contents of the control instruction 202, the process execution part 305 communicates with an apparatus different from the apparatus 101 itself, and/or another apparatus or a machine inside the apparatus 101, and/or cooperation devices (such as sensor, actuator) (not shown). In this case, the process execution part 305 is configured to include the functions necessary for the communication.

Next, the operation of the apparatus 101 will be described in detail.

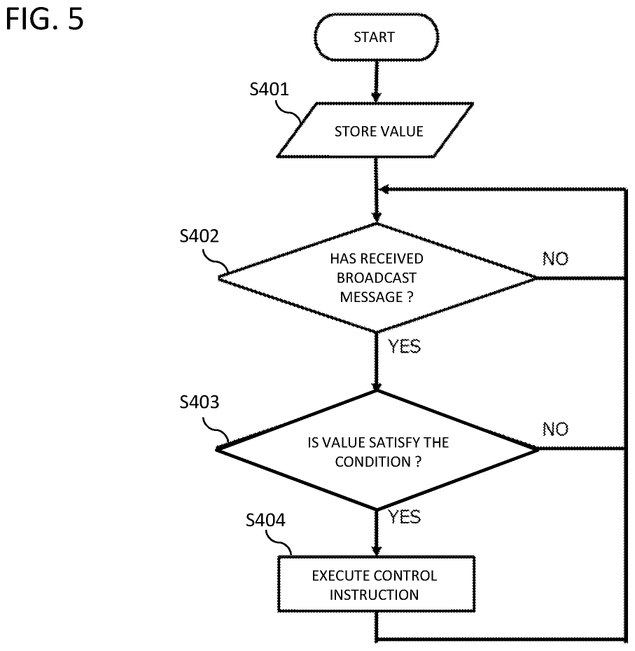

FIG. 5 illustrates a flowchart to show an example of operation of the apparatus 101.

At step S401, the apparatus 101 sets a value internally. Specifically, the apparatus 101 stores a predetermined value in the storage part 301.

For example, at the time of factory shipment, the apparatus 101 may store a predetermined initial value in the storage part 301.

Alternatively, for example, such a member like user or administrator of the apparatus 101 may input a predetermined value using the input part 302, for example, when installing the apparatus 101. Then, the apparatus 101 may store the value received by the input part 302 in the storage part 301.

Alternatively, for example, the apparatus 101 may include a sensor (not shown) that detects a state of the apparatus 101 itself or a state of a predetermined object. In this case, the apparatus 101 may store a value (such as temperature) measured by the sensor in the storage part 301 at the start time of operation. In this case, the sensor may measure a state of the apparatus 101 itself, or a state of a predetermined object at predetermined time intervals. Then, the apparatus 101 may read the value measured by the sensor and update the value held by the storage part 301.

Then, at step S402, the condition determination part 304 determines whether the reception part 303 has received the broadcast message 200. Specifically, the apparatus 101 monitors signal flowing on the network 100. Then, when the control apparatus 110 sends a broadcast message to the apparatus 101 via the network 100, the reception part 303 receives the message.

When the reception part has received the broadcast message 200 (Yes at step S402), the reception part 303 transmits the received broadcast message to the condition determination part 304. Then, the operation transit to step S403.

On the other hand, in a case where the reception part 303 has not received the broadcast message 200 (No at step S402), the apparatus 101 continues monitoring signals flowing on the network 100. Thus, the condition determination part 304 determines whether the reception part 303 has received the broadcast message 200 (step S402).

At step S403, the condition determination part 304 determines whether the condition included in the broadcast message 200 matches the value held by the apparatus 101 itself. Specifically, the condition determination part 304 determines whether or not the value held by the storage part 301 satisfies the condition 201 included in the received broadcast message 200. In a case where the value stored in the storage part 301 satisfies the condition 201 included in the received broadcast message 200 (Yes at step S403), the condition determination part 304 transmits the control instruction 202 included in the received broadcast message 200 to the process execution part 305. Then, the operation transits to step S404.

On the other hand, in case the value held by the storage part 301 does not satisfy the condition 201 included in the received broadcast message 200 (No at step S403), the operation transits back to step S402, and the operation will wait for the broadcast message 200.

At step S404, the process execution part 305 executes the content of the control instruction 202. Specifically, the process execution part 305 executes the content of the control instruction 202 by referring to the control instruction 202 transmitted by the condition determination part 304. Then, the operation transit back to step S402, and the operation will wait for the broadcast message 200.

### Modified First Example

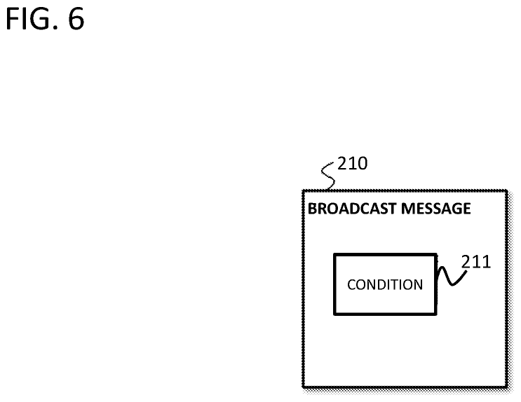

A modified first example of the present example embodiment is configured such that the broadcast message (the broadcast message 210 shown in FIG. 6) does not include a control instruction, while including the condition (the condition 211 shown in FIG. 6). In this configuration, in a case where the condition determination part 304 determines that the value stored in the storage part 301 satisfies the condition 211 included in received broadcast message 200, then the condition determination part 304 determines to transmit a predetermined control instruction to the execution part 305. Then, the process execution part 305 executes the predetermined control instruction based on the transmitted control instruction.

As described above, by the control system according to the present example embodiment, the apparatus 101 executes the instruction based on the broadcast message sent from the control apparatus 110. Therefore, by the control system according to the present example embodiment, the control apparatus 110 can control a plurality of apparatus 101 simultaneously by sending the broadcast message to the plurality of (two or more) apparatus 101. Thus, the control system according to the present example embodiment contributes to the control of a plurality of apparatus 101 efficiently and easily.

Furthermore, by the control system according to the present example embodiment, the apparatus 101 determines whether to execute an instruction according to the value held by the apparatus 101. Therefore, by the control system according to the present example embodiment, each instruction according to each apparatus 101 can be executed. Therefore, the control system in the present example embodiment contributes to the efficient and easy implementation of the control for each apparatus 101.

### Second Example Embodiment

A second example embodiment will be described in more detail using the drawings.

In the present example embodiment, the control apparatus receives an execution result executed by each apparatus. In the description of the present example embodiment, the description of the parts which overlap with the first example embodiment will be omitted. Furthermore, in the description of the present example embodiment, the same components as those of the above example embodiment will be denoted by the same reference numerals, and the description thereof will be omitted. Further, in the description of the present example embodiment, the description of the same effects as those of the above example embodiment will be omitted.

An entire configuration of the control system according to the present example embodiment is as shown in FIG. 2. Also, the broadcast message 200 sent by the control apparatus 110 is as shown in FIG. 3.

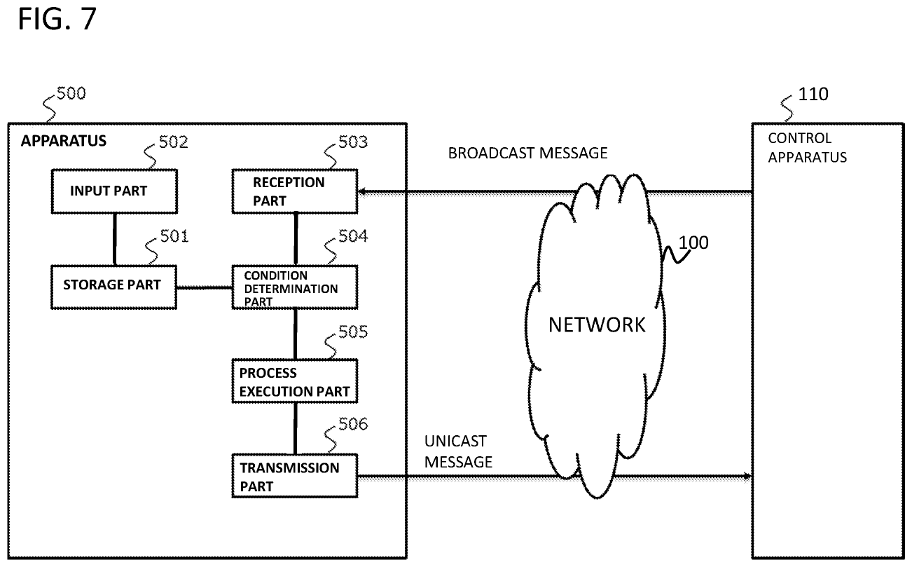

FIG. 7 illustrates a block diagram to show an example of an internal configuration of an apparatus 500 concerning to the present example embodiment. It is assumed that the apparatus 500 corresponds to the apparatus 101a to 101e shown in FIG. 2. The difference between the apparatus 500 shown in FIG. 7 and the apparatus 101 shown in FIG. 4 is that the apparatus 500 shown in FIG. 7 includes a transmission part 506. The storage part 501, the input part 502, the reception part 503, and the condition determination part 504 illustrated in FIG. 7 are similar to the storage part 301, the input part 302, the reception part 303, and the condition determination part 304 illustrated in FIG. 4, and are omitted detailed explanation.

The process execution part 505 transmits the execution result of the processing to the transmission part 506, after the process execution part 505 executes a processing (the control instruction 202 or a predetermined process) in a case where the value held (stored) in the storage part 501 of the apparatus 500 satisfies the condition included in the broadcast message 200.

The transmission part 506 sends the execution result executed by the process execution part 505 to the control apparatus 110 via the network 100. For example, the transmitting part 506 may send, to the control apparatus 110, a message that includes information (apparatus ID) to identify the apparatus 500 as well as the execution result executed by the process execution part 505. The transmission part 506 may be realized by using, for example, a wired or wireless transmitter, a network interface card (NIC), and so on.

Next, the operation of the apparatus 500 according to the present example embodiment will be described in detail.

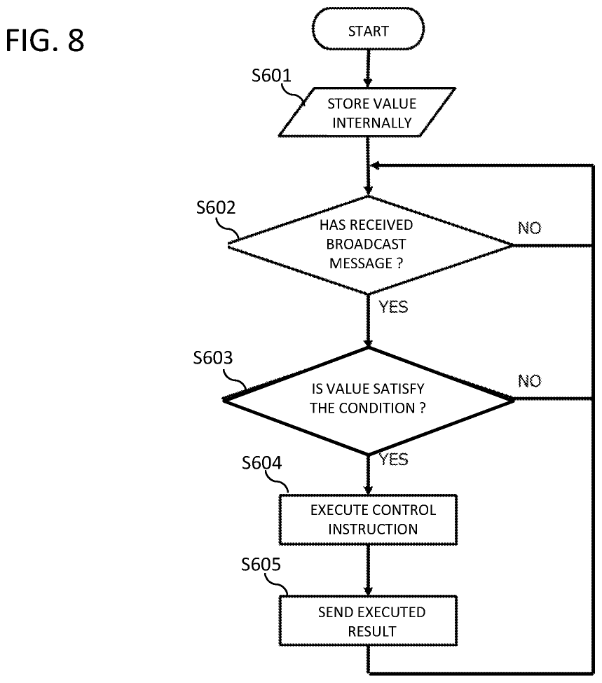

FIG. 8 illustrates a flowchart to show an example of the operation of the apparatus 500 according to the present example embodiment. The operation from step S601 to S603 shown in FIG. 8 are the same as the operation from step S401 to S403 shown in FIG. 5, and thus the detailed description will be omitted.

At step S604, the process execution part 505 executes the contents of the control instruction 202. Specifically, the process execution part 505 refers to the content of the control instruction 202 transmitted from the condition determination part 504, and executes a control instruction based on the control instruction 202. Then, the process execution part 505 transmits the execution result of the control instruction to the transmission part 506.

At step S605, the transmission part 506 sends the execution result. Specifically, the transmission part 506 sends the execution result transmitted from the process execution part 505 to the control apparatus 110 via the network 100. Then, the operation transits back to step S602, and will wait for the broadcast message 200.

Note that each apparatus 500 may send the executed result to the control apparatus 110 at a timing different from that of the other apparatus 500, in order to avoid congestion of the network 100. For example, the transmitting part 506 may generate a random number within a predetermined numerical value range, then send the execution result to the control apparatus 110 after delaying a time period of the generated random number.

As described above, in the control system according to the present example embodiment, the apparatus 500 sends the execution result of the processing to the control apparatus 110. Therefore, by the control system according to the present example embodiment, the control apparatus 110 can grasp the apparatus 500 that satisfies the control instruction. Furthermore, by the control system according to the present example embodiment, the control apparatus 110 can grasp the execution result of the processing when the apparatus 500 executes processing in response to the broadcast message 200. Thus, the control system according to the present example embodiment contributes to the control of the plurality of apparatus 500 efficiently and easily, and to the adequate operation management of the apparatus 101.

Some or all of the described example embodiments above may be described as in the following modes, however, is not limited thereto.

(Mode 1) An apparatus according to the first aspect described above is provided.
(Mode 2) The apparatus according to mode 1, wherein, the broadcast message includes the condition and a control instruction;

the condition determination part notifies the control instruction to the process execution part, in a case where the value stored in the storage part satisfies the condition included in the broadcast message;

the process execution part executes the control instruction that is notified from the condition determination part.

(Mode 3) The apparatus according to mode 1 or mode 2, further comprising,

a transmission part that send the execution result of the control instruction executed by the process execution part, in a case where the value stored in the storage part satisfies the condition included in the broadcast message.

(Mode 4) The apparatus according to any one of modes 1 to 3, wherein,

the value stored in the storage part is at least one selected from the group of a fixed value and a variable value, corresponding to at least one type.

(Mode 5) The apparatus according to any one of modes 1 to 4, wherein,

the value stored in the storage part is determined based on at least one selected from the group consisting of a setting information, an attribute and a state of the apparatus itself.

(Mode 6) The apparatus according to any one of modes 1 to 5, further comprising,

a sensor(s) that measures at least one of a state of the apparatus itself, or a state of predetermined object other than the apparatus itself, wherein, the storage part stores the value measured by the sensor(s).

(Mode 7) The apparatus according to any one of modes 1 to 6, wherein,

the storage part stores one or more values corresponding to the one type.

(Mode 8) A control system according to the second aspect described above is provided.
(Mode 9) The control system according to mode 8, wherein, the apparatus has a transmission part that sends execution result of the processing executed by the process execution part to the control apparatus, in a case where the value stored in the storage part satisfies the condition included in the broadcast message, further comprising, a control apparatus receives the execution result corresponding to the broadcast message sent from the apparatus.
(Mode 10) An apparatus control method according to the third aspect described above is provided.
(Mode 11) The apparatus control method according to mode 10, wherein the broadcast message includes the condition and the control instruction, the method further comprising,

executing the control instruction, in a case where the value stored in the storage part satisfies the condition included in the broadcast message.

(Mode 12) The apparatus control method according to mode 10 or 11, further comprising,

transmitting the execution result of the processing executed by the apparatus to the control apparatus, in a case where the value is included in the broadcast message and the value satisfies the condition.

(Mode 13) A program according to the fourth aspect as described above is provided.
(Mode 14) The program executed by a computer that controls the apparatus according to mode 13, wherein the broadcast message includes the condition and a control instruction, the program further comprising,

executing the processing in a case where the value satisfies the condition included in the broadcast message.

(Mode 15) The program according to mode 13 or 14, further comprising, transmitting to the control apparatus from the apparatus an execution result of processing, in a case where the value satisfies the condition included in the broadcast message.

The mode described as mode 8 can be expanded to the modes described as modes 2 to 7, similarly to the modes shown on mode 1.

The disclosure of the above-mentioned patent documents is incorporated herein by reference. Within the ambit of the entire disclosure of the present invention (including the claims), modifications and adjustments of the example embodiment are possible based on the fundamental technical concept of the invention. In addition, various combinations or selections of various disclosed elements (including each element of each claim, each element of each example embodiment, each element of each drawing, etc.) are possible within the ambit of the entire disclosure of the present invention. That is, the present invention of course includes various modifications and alterations that can be made by those skilled in the art according to the entire disclosure and technical concept. In particular, with regard to the numerical ranges described herein, it should be understood that any numerical value or small range falling within the relevant range is specifically described even if it is not otherwise explicitly described.

### REFERENCE SIGNS LIST

100: network

110: control apparatus

101, 101a to 101e, 500, 1000: apparatus

200, 210: broadcast messages

201, 211: condition

202: control instruction

301, 501, 1001: storage part

302, 502: input part

303, 503, 1002: reception part

304, 504, 1003: condition determination part

305, 505, 1004: process execution part

506: transmission part

1. An apparatus, comprising:
a storage part that stores a value corresponding to at least one type;
a receiving part that receives a broadcast message which includes a condition representing the value corresponding to the type, from a control apparatus via a network;
a condition determination part that determines whether or not the value stored in the storage part satisfies the condition included in the broadcast message;
a process execution part that executes a predetermined processing in a case where the value stored in the storage part satisfies the condition.

2. The apparatus according to claim 1, wherein:
the broadcast message includes the condition and a control instruction;
the condition determination part notifies to the process execution part the control instruction, in a case where the value stored in the storage part satisfies the condition included in the broadcast message;
the process execution part executes the control instruction notified from the condition determination part.

3. The apparatus according to claim 1, further comprising:
a transmission part that sends an executed result of processing executed by the process execution part to the control apparatus, in a case where the value stored in the storage part satisfies the condition included in the broadcast message.

4. The apparatus according to claim 1, wherein:
the storage part stores at least one selected from the group consisting of a fixed value and a variable value, corresponding to at least one type.

5. The apparatus according to claim 1, wherein:
the storage part stores a value which is determined based on at least one selected from the group consisting of a setting information, an attribute and a state of the apparatus itself.

6. The apparatus according to claim 1, further comprising:
a sensor(s) that detects at least one selected from the group consisting of a state of the apparatus itself and a state of a predetermined object, wherein,
the storage part stores the value measured by the sensor(s).

7. The apparatus according to claim 1, wherein:
the storage part stores one or more of the values corresponding to one type.

8. A control system, comprising:
a control apparatus that sends a broadcast message which includes a condition corresponding to at least one type;
one or more of apparatus that connects to the control apparatus via a network, and the apparatus further comprising:
a storage part that stores a value corresponding to at least one type;
a receiving part that receives the broadcast message which includes a condition representing the value corresponding to the type, from the control apparatus via the network;
a condition determination part that determines whether or not the value stored in the storage part satisfies the condition included in the broadcast message;
a process execution part that executes a predetermined processing in a case where the value stored in the storage part satisfies the condition.

9. The control system according to claim 8, wherein:
the apparatus has a transmission part that sends to the control apparatus, an execution result of the processing executed by the process execution part, in a case where the value stored in the storage part satisfies the condition included in the broadcast message;
the control apparatus receives the execution result corresponding to the broadcast sent, from the apparatus.

10. An apparatus control method, wherein an apparatus has a storage part that stores a value corresponding to at least one type, comprising:
receiving a broadcast message via a network which includes a condition representing the value corresponding to the type;
determining whether or not the value satisfies the condition included in the broadcast message;
executing a predetermined processing in a case where the value satisfies the condition.

11. The apparatus control method according to claim 10, wherein the broadcast message includes the condition and a control instruction, the method further comprising:
executing the control instruction in a case where the value satisfies the condition included in the broadcast message.

12. The apparatus control method according to claim 10, wherein the apparatus sends an execution result of the processing in a case where the value is included in the broadcast message and the value satisfies the condition.

13-15. (cancelled)
